(19) United States
(12) Patent Application Publication
(10) Pub. No.: US 2014/0038152 A1
(43) Pub. Date: Feb. 6, 2014

(54) MEDICAL VISUALIZATION METHOD AND SYSTEM

(71) Applicant: Sandro Micieli, Toronto (CA)

(72) Inventor: Sandro Micieli, Toronto (CA)

(21) Appl. No.: 13/562,316

(22) Filed: Jul. 31, 2012

(51) Int. Cl. G09B 23/28

(52) U.S. Cl. 434/267

(57) ABSTRACT

A system for generating a patient report of a medical consultation by a health care professional using a terminal, the method comprising the steps of, via said terminal receiving patient information data; prompting data entry of said patient condition via a graphical user interface (GUI) associated with said terminal; presenting on said GUI at least one image of the human anatomy associated with said entered patient condition; manipulating said at least one image; presenting on said GUI treatment options; storing on a computer readable medium said patient information data, said at least one image, said treatment options in a database structure; and providing said patient information data, said at least one image, said treatment options to said patient or a third party.

### FIELD OF THE INVENTION

The present invention relates to a medical visualization tool.

### DESCRIPTION OF THE RELATED ART

Human anatomical models and charts are often used for teaching purposes in medical health facilities, research institutes and educational settings. When working with patients, anatomical models and charts assist patients in visualizing areas of the human anatomy pertaining to the patient's condition, and therefore aid in developing understanding of the diagnosis. Anatomical models are typically made from plastic or resin, however despite being lightweight these models require physical storage on shelves or counters. In addition, the removable parts of the models may be misplaced or lost. Also, the repeated removal and application of the removable parts can cause wear over time, or damage. Similarly, anatomical charts require storage and are also subject to wear and tear. The charts are often made from paper or plastic laminate for framing or tacking on a wall, or portable-stand display, and therefore can be cumbersome. It is also obvious that a great many anatomical models and charts pertaining to the many different regions of the human anatomy may need to be on hand. Another drawback of using models and anatomical charts is that these aids remain in the examination room or medical facility, and the patient can no longer reference these aids once they leave the examination room or medical facility.

It is an object of the present invention to mitigate or obviate at least one of the above-mentioned disadvantages.

### SUMMARY OF THE INVENTION

In one of its aspects, there is provided an apparatus comprising a non-transitory computer readable medium with instructions stored thereon, said instructions executable by a processor to cause the processor to:
prompt a user to input a query pertaining to a patient condition via a graphical user interface (GUI) of said apparatus;
retrieve at least one anatomical representation of a human body in response to said query;
present said at least one anatomical representation associated with said patient condition on said GUI;
allow manipulation of said at least one anatomical representation through scaling, rotation, dragging and annotation;
recommend treatment options and medicaments for a prescription;
provide educational material pertaining to said patient condition;
compile a report pertaining to said patient condition, said report including said at least one anatomical representation, said treatment options, said medicaments with associated data; and
provide said report to said patient via electronic means.

In another of its aspects, there is provided a method for generating a patient report of a medical consultation by a health care professional using a terminal, the method comprising the steps of, via said terminal:
receiving patient information data;
prompting data entry of said patient condition via a graphical user interface (GUI) associated with said terminal to provide a query associated with said patient condition;
presenting on said GUI at least one image of the human anatomy associated with said entered patient condition;
manipulating said at least one image;
presenting on said GUI a recommended prescription for said patient condition including information related to said patient condition and said prescription;
storing on a computer readable medium said patient information data, said at least one image, said prescription data in a database structure; and
providing said patient information data, said at least one image, said prescription data.

In yet another of its aspects, there is provided a system for generating a patient report of a medical consultation by a health care professional, the system comprising:
a central server for processing requests from at least one client terminal associated with said health care professional;
a content server communicatively coupled to the central server, said content server comprising content associated with at least one patient condition;
a health care professional information database comprising user objects pertaining to a medical facility having said at least one client terminal;
a patient information database comprising user objects pertaining to said patient; and
a messaging server for sending said report from the medical consultation to said patient or an authorized third party.

Advantageously, the patient receives a summary of the medical consultation, including detailed images of the human anatomy pertaining to the patient condition, prescription data, over-the-counter (OTC) medication, drug information, and reference materials, either in the examination room or after the medical consultation via email, and so forth.

### BRIEF DESCRIPTION OF THE DRAWINGS

Several exemplary embodiments of the present invention will now be described, by way of example only, with reference to the appended drawings in which:

FIG. 1 shows an exemplary medical visualization system;

FIG. 2 shows a schematic diagram of an exemplary terminal device;

FIG. 3 is a flow chart diagram illustrating an exemplary method for updating terminal software application from a remote server;

FIG. 4 shows an exemplary user interface for use with the system of FIG. 1;

FIG. 5a shows an exemplary user interface with a plurality of buttons associated with patient conditions;

FIG. 5b shows a physiological representation of a human head showing portions pertaining to a particular patient condition;

FIGS. 5c and 5d show user interfaces displaying information for educating the patient about an exemplary patient condition;

FIGS. 5e and 5f show user interfaces displaying information for educating the patient about an exemplary patient condition and associated medicaments;

FIG. 6 is a flow chart diagram illustrating an exemplary method for generating a patient report of a medical consultation; and

FIGS. 7a, 7b and 7c show user interfaces displaying various medical tools.

### DETAILED DESCRIPTION OF EXEMPLARY EMBODIMENTS

The detailed description of exemplary embodiments of the invention herein makes reference to the accompanying block diagrams and schematic diagrams, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented.

Moreover, it should be appreciated that the particular implementations shown and described herein are illustrative of the invention and its best mode and are not intended to otherwise limit the scope of the present invention in any way. Indeed, for the sake of brevity, certain sub-components of the individual operating components, conventional data networking, application development and other functional aspects of the systems may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

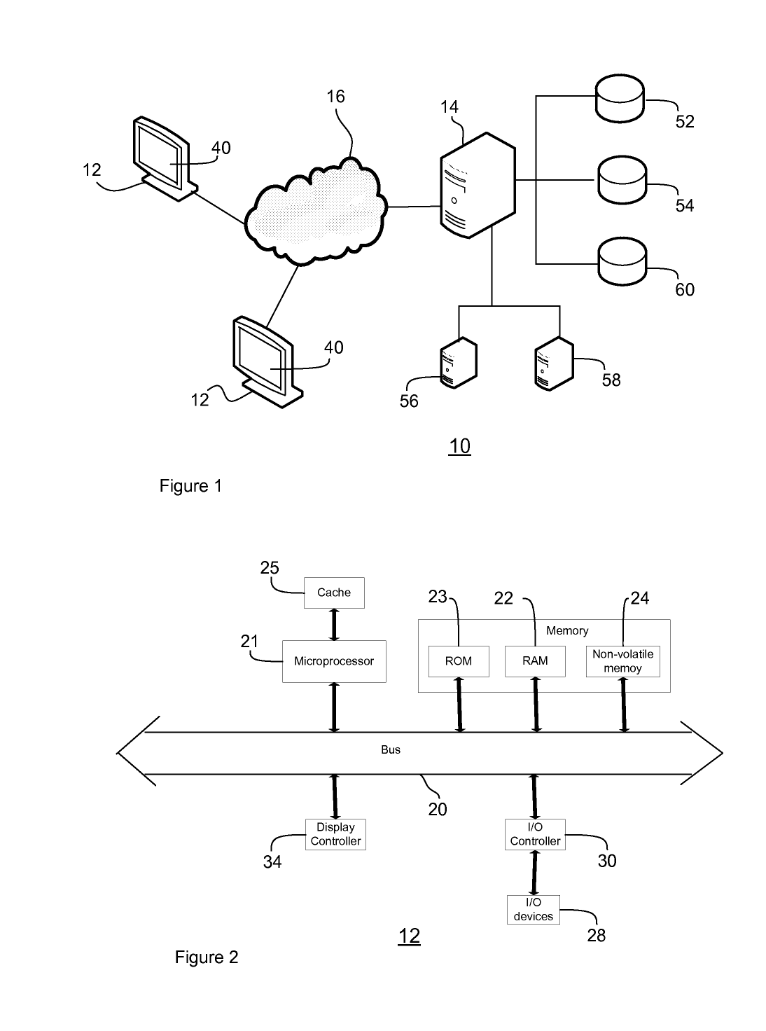

Many of the methods of the invention may be performed with a digital processing system, such as a conventional, general purpose computer system. Special purpose computers which are designed or programmed to perform only one function may also be used. FIG. 1 shows an exemplary medical visualization system, generally identified by reference numeral 10, comprising a plurality of computing devices 12 in communication with a central server 14 for providing medical information. The computing devices 12, or terminals are communicatively coupled to the central server 14 via a network 16, either though a wired connection, or a wireless connection. For example, the network 16 may be the Internet, or a mixture of different networks. The devices 12 run a software application which comprises a visual tool configured to show images of the human anatomy pertaining to a patient condition, including reference materials for patient education. The terminals 12 are generally installed in a medical facility, such as an outpatient clinic, a hospital, an emergency room, or in a general practice examination room. The terminals 12 assist the health care professional, such as a physician, collect data on the patient's condition during a medical consultation, and aid in the medical diagnosis. The terminals 12 are especially useful to physicians specializing in particular areas of medicine, such as cardiologists, endocrinologists, neurologists, urologists, paediatricians, obstetricians, allergists, psychiatrists and surgeons.

FIG. 2 shows one example of a typical computer system of terminal 12. Note that while FIG. 2 illustrates various components of a computer system, it is not intended to represent any particular architecture or manner of interconnecting the components as such details are not germane to the present invention. It will also be appreciated that network computers and other data processing systems which have fewer components or perhaps more components may also be used with the present invention. The computing system may be in the form of any kind of general processing structure, and may for example include any computing terminal 12, such as, a personal computer, a laptop, a tablet, a computer server, a computerized kiosk, a cellular phone, and a smartphone.

The computer system, which is a form of a data processing system, includes a bus 20 which is coupled to a microprocessor 21 and a read only memory (ROM) 22 and volatile random access memory (RAM) 23 and a non-volatile memory 24. The microprocessor 21 is coupled to cache memory 25. The bus 20 interconnects these various components together and also interconnects these components 21, 22, 23, and 24 to a display controller 34 and to peripheral devices such as input/output (I/O) devices 28 which may be mice, keyboards, modems, network interfaces, printers, scanners, video cameras and other devices which are well known in the art. Typically, the input/output devices are coupled to the system through input/output controllers 30. The bus 20 may include one or more buses connected to each other through various bridges, controllers and/or adapters as is well known in the art.

It will be apparent from this description that aspects of the present invention may be embodied, at least in part, in software. That is, the techniques may be carried out in a computer system or other data processing system in response to its processor, such as a microprocessor, executing sequences of instructions contained in a memory, such as a machine readable medium, or ROM 22, volatile RAM 23, non-volatile memory 24, cache 25 or a remote storage device. In various embodiments, hardwired circuitry may be used in combination with software instructions to implement the present invention. Thus, the techniques are not limited to any specific combination of hardware circuitry and software nor to any particular source for the instructions executed by the data processing system. In addition, throughout this description, various functions and operations are described as being performed by or caused by software code to simplify description. However, those skilled in the art will recognize what is meant by such expressions is that the functions result from execution of the code by a processor, such as the microprocessor 21. The machine readable medium includes any mechanism that provides (i.e., stores and/or transmits) information in a form accessible by a machine (e.g., a computer, network device, personal digital assistant, any device with a set of one or more processors, etc.). For example, machine readable media includes recordable/non-recordable media (e.g., ROM; RAM; magnetic disk storage media; optical storage media; flash memory devices; etc.), as well as electrical, optical, acoustical or other forms of propagated signals (e.g., carrier waves, infrared signals, digital signals, etc.). Each of the terminals 12 comprises a display screen 40 on which information is displayed, with a graphical user interface (GUI). The GUI includes, but is not limited to, the “desktop” of the operating system, controls such as taskbars and scroll bars, any icons and application windows.

In more detail, the central server 14 comprises a similar computing system as described above, however, it may further comprise data structures, such as, databases which stores classification information. Further, the central server 14 may include a server process that responds to requests from one or more client programs. The process may include, for example, an HTTP server or other server-based process (e.g., a database server process, XML server) that interfaces to one or more client programs distributed among one or more client systems. Communicatively coupled to the central server 14 is a health care professional information database 52, a patient information database 54, a content server 56, a messaging server 58, and a third party reference database 60, the functions of which will be described below.

The health care professional information database 52 includes user objects with attributes for storing predefined information pertaining to the medical facility with the installed terminal 12, such as identification data, geographical location, authorized health care professional details, terminal 12 data, such as, software application version, hardware version, user information, and analytics data. The patient information database 54 includes user objects for each patient. Accordingly, an exemplary user object for a patient includes attributes for storing predefined information about the user, such as, name, gender, contact information details, such as email address or phone number, records of medical consultations, and a patient medical history.

The content server 56 includes a plethora of information, such as, medical illustrations, industry guidelines, videos, documents, multimedia, drug information, detailing aids, monographs, research documents, patient literature, and public health awareness information. The content server 56 may include 2D or 3D representations of the various systems of the human body, such as, the cardio-vascular (circulatory) system, digestive system, endocrine system, lymphatic system, nervous system, sensory system, urinary/reproductive system, respiratory system, integumentary system, skeletal system and musculature system. The content server 56 also provides the content to terminals 12, where the content is cached in cache 25. Therefore, the terminals 12 have always have access to the content in the event of network congestion or content server 56 unavailability.

The messaging server 58 receives queries from the terminals 12 via the central server 14 to send particular medical content, including patient reports from the medical consultation to the patient, care provider or other authorized third party. The messaging server 58 hosts a messaging application (e.g., Microsoft Exchange, Lotus Notes, etc.).

The third party reference database 60 comprises drug information. One such exemplary database is the Compendium of Pharmaceuticals and Specialties (e-CPS) available online from the Canadian Pharmacists Association. This resource provides health care professionals with the most current information on drug products available in Canada, by searching for drug monographs. The drug information may be accessed using queries pertaining to the brand name, generic name, therapeutic class, or manufacturer. In addition, the third party reference database 60 provides access to drug updates, such as new indications, new dosage forms, new formulations, clinical information on drug interactions, directories with contact information to poison control centers and health organizations and, a product identification tool for retrieving information on drugs based on a descriptive query.

The central server 14, the content server 56, the messaging server 58 and databases 52, 54 and 60 provide centralized computing functionality for the system 10, or a private cloud computing platform. The cloud network resources are therefore only available to registered and authorized users or health care professionals, and only via registered and authorized terminals 12. Centralized computing results in cost savings, ease of administration, enhanced security and facilitates audit processes. Most of the processing is done on central server 14, the content server 56 and the messaging server 58, maintenance of applications is isolated to the servers 14, 56, 58 and not each individual node 12, also reducing administrative overhead.

Each terminal 12 is communicatively coupled to the central server 14 via a network interface, such that each terminal 12 includes a network address, such as an IP address or MAC address. The terminal 12 is also associated with a unique identifier, such as a terminal ID, as assigned by the server 14. As part of an initial configuration process for a terminal 12 being installed for participation within the system 10, the terminal ID and network address of the terminal 12 are forwarded to the central server 14 for registration. Other information associated with the terminal 12, such as geographical location, device 12 data, such as software application version, hardware version, device 12 analytics data, health care professional details, identity of medical facility, and so forth, is also transmitted to the central server 14 for storage in the user database 54. Generally, at each instance when the terminal 12 is powered on and communicatively coupled to the central server 14 via network 16, the software application version number associated with the terminal 12 is sent to the central server 14. Subsequently, the version number of the software application on the terminal 12 is compared to the version number of the software application available on the central server 14. When the version number of the software application on the terminal 12 is superseded by that available on the central server 14, then the terminal 12 requests an update of the software application, and the updated software application or patches, are pushed to the terminal 12 for auto-installation.

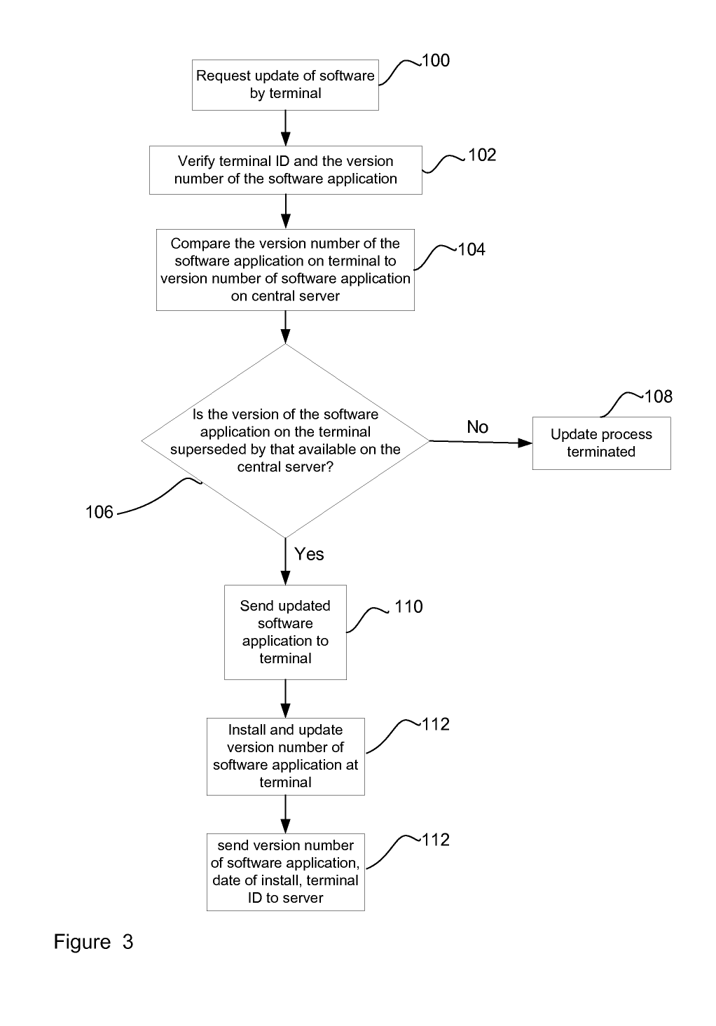

FIG. 3 shows a flow chart with exemplary steps for updating the software application on terminals 12. In step 100, a terminal 12 requests an update of the software application from the central server 14, the terminal 12 request includes at least the version number of the software application, network address and terminal ID. Next, the central server 14 verifies the terminal ID and the version number of the software application that was last installed on the terminal 12 (step 102). A comparison of the version number of the software application on the terminal 12 and the version number of the software application on the central server 14 is performed by the central server 14 (step 104); a determination is made whether the version number of the software application on the terminal 12 is superseded by that available on the central server 14 (step 106). When the version number of the software application on the terminal 12 is identical to the version number available on the central server 14, then the process ends (step 108). However, when the version number of the software application on the terminal 12 is superseded by that available on the central server 14, then the central server 14 sends the updated software application to the terminal 12 (step 110). Subsequently, the terminal 12 automatically installs the software application and updates the software application version number thereon (step 112). Once installed, the terminal 12 sends confirmation of the installed software application, including terminal ID, version number, installed updates, date and time of install, to the central server 14 (step 114), and the process ends.

Alternatively, the central server 14 automatically provides up-to-date versions of the client software application to the terminals 12 for auto-installation, when the version number of the software application available on the terminal 12 is superseded by that on the central server 14. The central server 14 periodically determines which of the terminals 12 are online and operational using a ping command, as is well known in the art, or by other means.

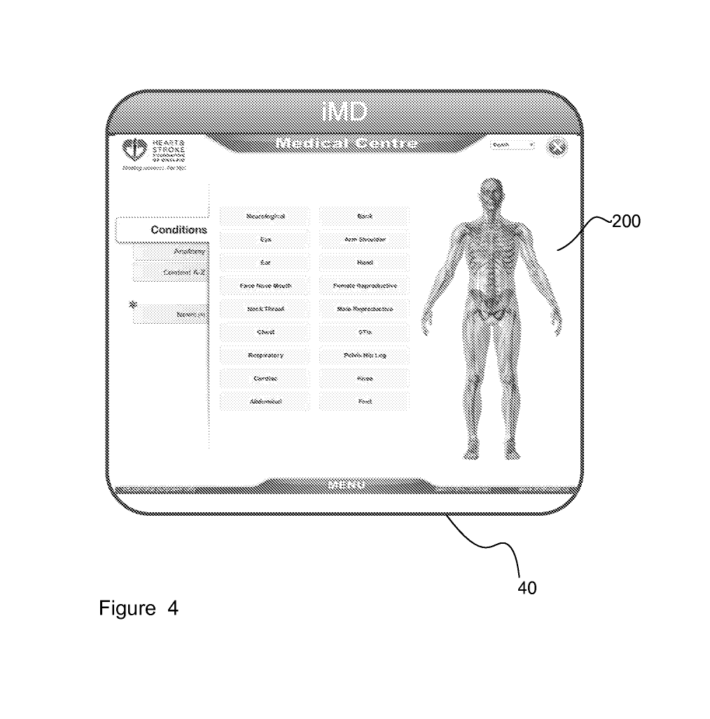

The software application comprises a visual tool application which interfaces with the central server 14 via a suitable protocol. In operation, a user or operator at terminal 12 initiates a visual tool application on the display 40 and dialog box (not shown) is presented for the user to authenticate with the central server 14 by entering the system credentials. Once authenticated, a graphical user interface (GUI) 200 is generated by the terminal 12 and displayed on the touch screen 40 associated with the terminal 12, as shown in FIG. 4. As is typical with touch screen interfaces, touching a particular icon, tab, button or text will launch an application or allow the user to access a resource associated therewith.

In more detail, the touch screen 40 associated with the terminal 12 displays regions of the human body, medical conditions, diseases, illnesses, medical resources and treatment options. Typically, the terminal 12 is located in the examination room, and is operated by a health care professional, such as a doctor or nurse. Users can interact with the terminal 12 through any form of input and output, such as text input, speech recognition, text output, text-to-speech, graphics, recorded files and video.

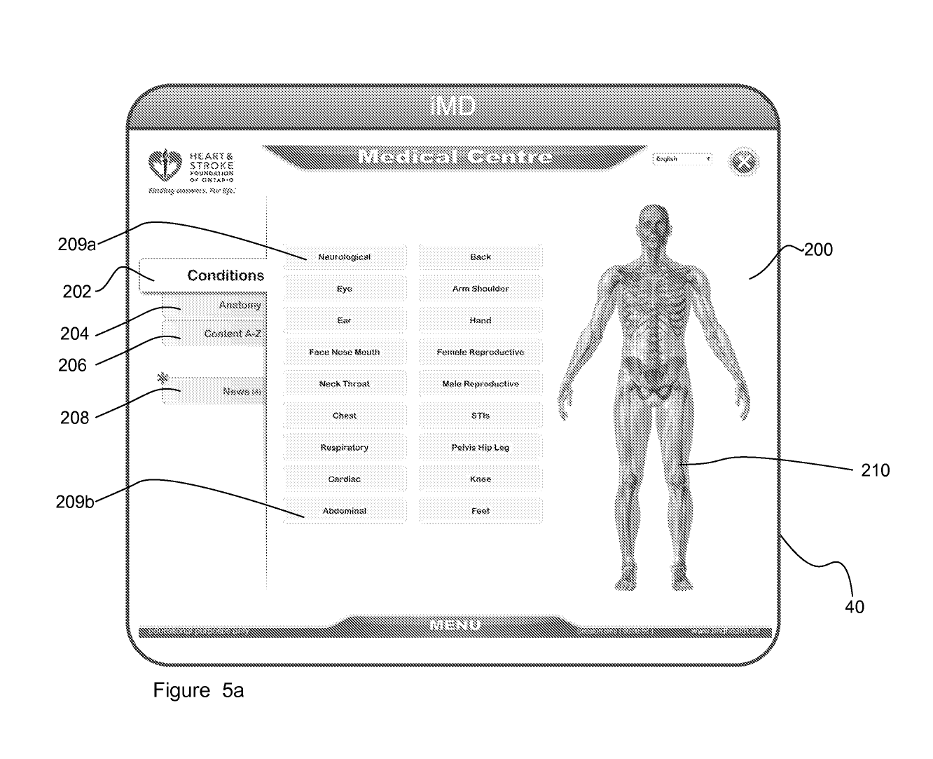

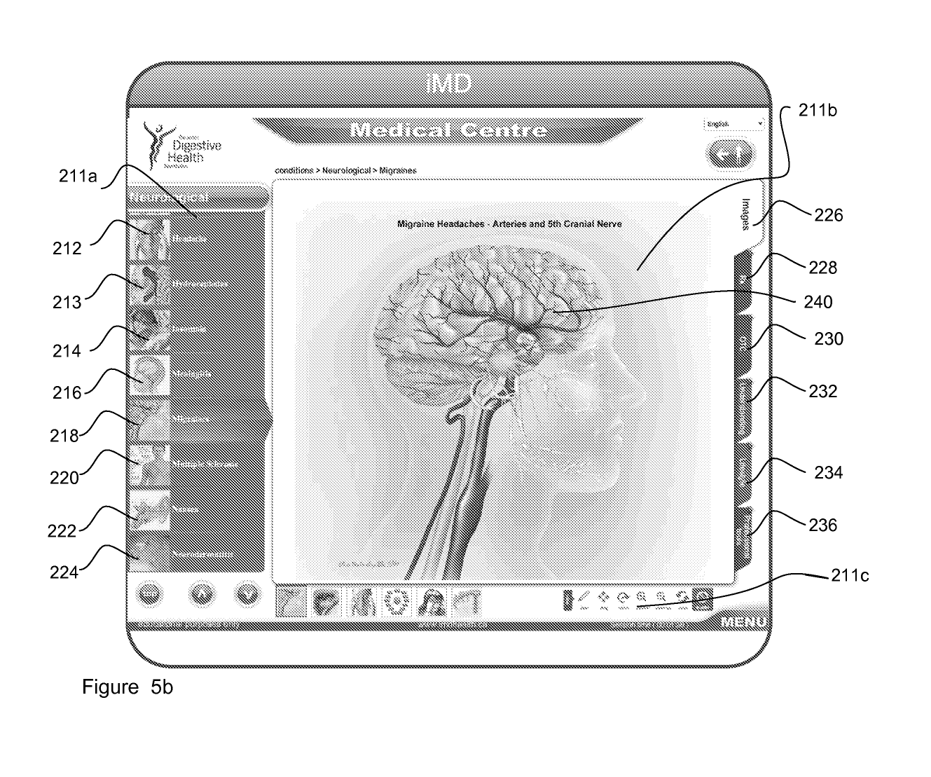

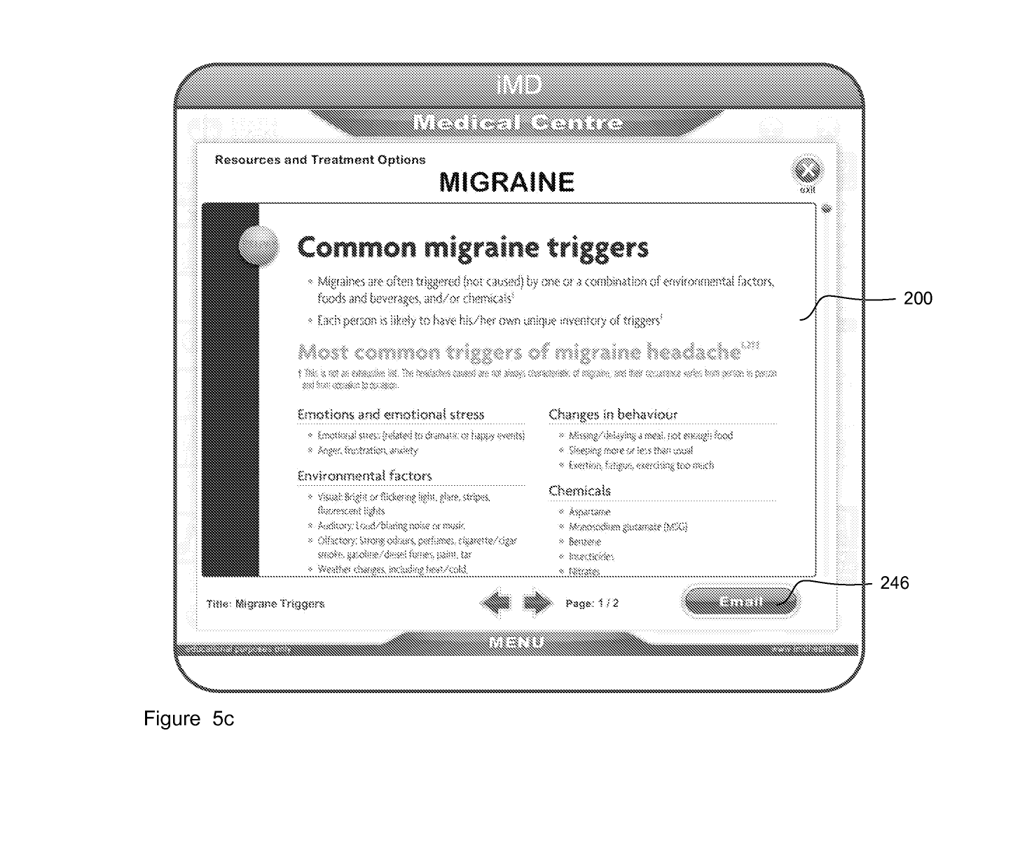

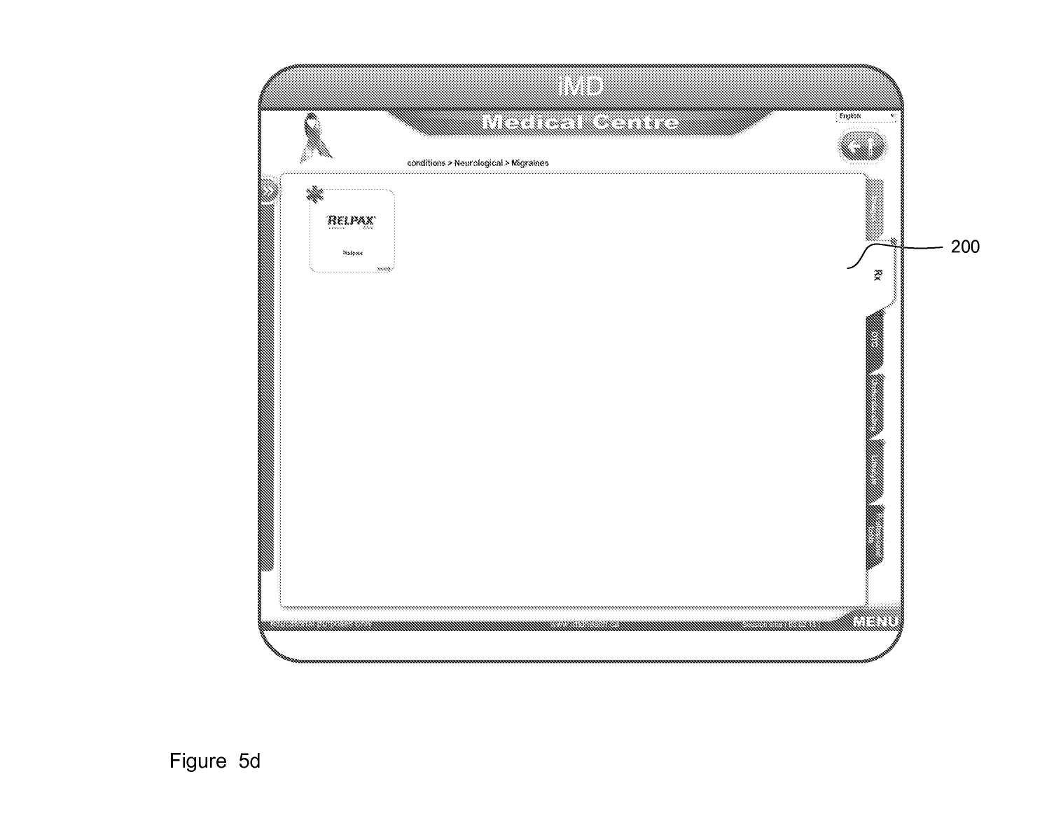

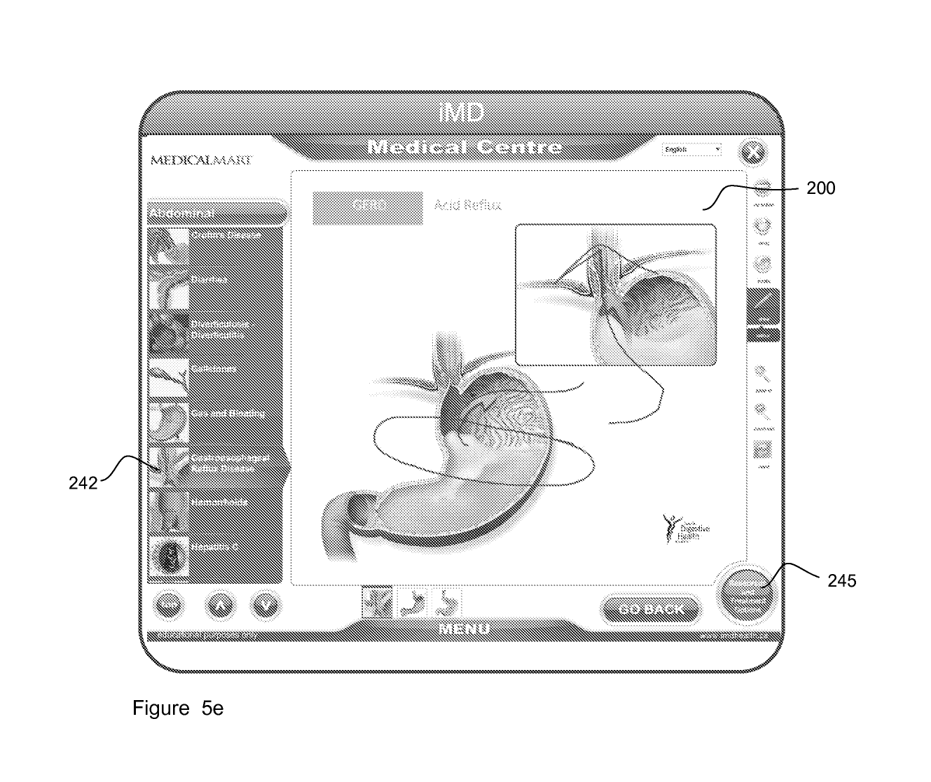

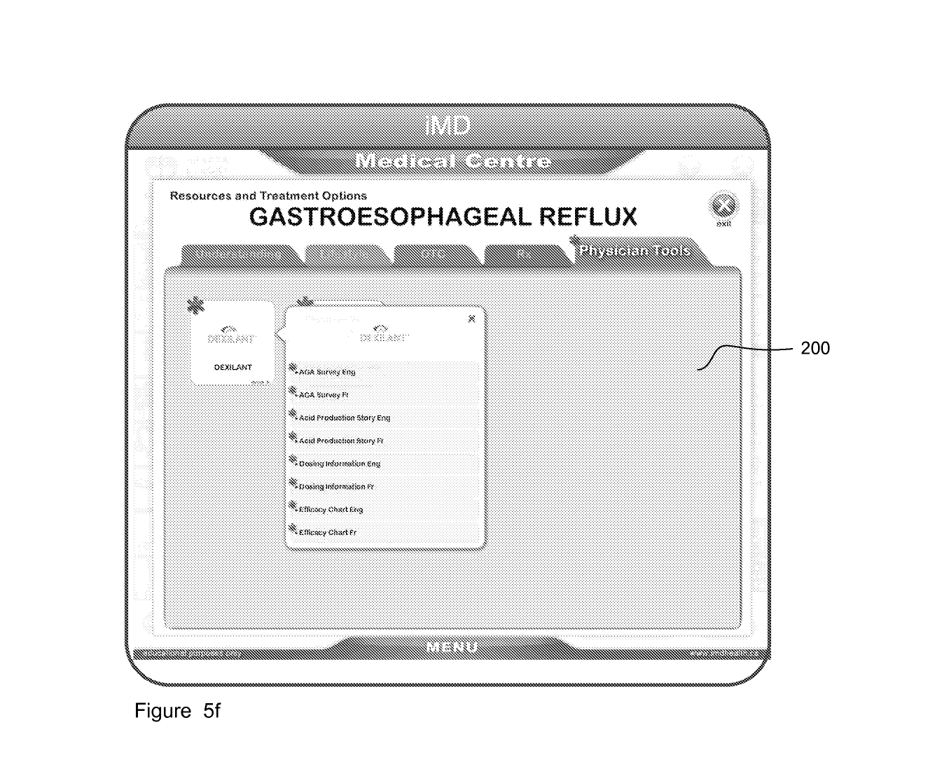

Looking at FIG. 5a, there is shown an exemplary user interface 200 with a plurality of categories related to patient conditions, human anatomy, and an index of the human anatomy, among others. Each category is associated with a tab 202, 204, 206 or 208 which may include icons or text corresponding to that category. Enabling any one of the tabs 202, 204, 206, 208 causes the processor 21 to display a page related to the chosen category. For example, selection of tab 202 corresponding to patient conditions yields a page having a plurality of GUI objects, such as buttons 209a, 209b, 209c associated with patient conditions, such as neurological, respiratory, and cardiac, and so forth. The displayed page includes an image of the human anatomy 210 with a highlighted portion corresponding to the selected condition. Alternatively, the operator can select the relevant part of the displayed image corresponding to the reported patient condition. Tab 208 links the user to a customized news page pertaining to the patient condition.

As shown in FIG. 5b each patient condition category comprise further sub-categories which allow further refining of the chosen category. The user interface 200 is divided into three regions, a sub-category frame 211a, an image frame 211b and a menu frame 211c. For example, if button 209a associated with a “Neurological” condition is selected, then sub-categories corresponding to neurological conditions are displayed, such as: headache 212, hyrocephalus 213, insomnia 214, meningitis 216, migraines 218, multiple sclerosis 220, nausea 222, neurodermititis 224, and so forth. The user interface 200 also includes a plurality of tabs 226, 228, 230, 232, 234, 236 associated with images, prescriptions, over-the-counter (OTC) medication, drug information, patient reference materials, lifestyle and professional tools, respectively.

If, for example, the tab 218 associated with the migraines sub-category is selected then an exploded image 240 of a head is presented on the user interface 200. As shown in FIG. 5b, the image 240 may be 2 dimensional or 3 dimensional, and may include multimedia components. In FIG. 5b, a physiological representation of the head is displayed to show the particular parts of the human anatomy that contribute to migraines, such as the arteries and the 5^{th} cranial nerve. The image 240 is interactive, such that it can be dragged, rotated or scaled depending on the particular region of interest. In addition, the image 240 can be annotated, such that additional data may be included with the image 240, such as notes, diagnosis and/or treatment recommendations. Accordingly, each structure of the human anatomy may be viewed in greater detail through zooming and rotation of the images between the different views such as anterior, posterior, and lateral, including exploded views of the structure. The operator can also specify a structure by name and can obtain a highlighted view, or summon an identifying label on the structure.

FIGS. 5c and 5d show user interfaces 200 displaying information for educating the patient about an exemplary patient condition, such as migraines. The information may include resources and treatment options. For example, as shown in FIG. 5c, the information may include common triggers for migraines such as stress, environmental factors, behavioural changes and chemical agents. FIG. 5d shows a user interface 200 displaying medicaments for migraines, which may include over-the-counter medicaments or prescription medicaments.

As shown in FIG. 5e, when a button 209b, of FIG. 5a, associated with an “Abdominal” condition is selected, then sub-categories corresponding to an abdominal condition are displayed, such as: Crohn's disease, diarrhea, gallstones, gastroesophogeal reflux disease, hepatitis C and so forth. Each sub-category is associated with a hyperlinked tab. If, for example, a tab 242 associated with the gastroesophogeal reflux disease sub-category is selected then an image 244 of the stomach and the esophagus is presented on the user interface 200. As shown in FIG. 5e, the image 244 may be annotated by the healthcare professional while educating the patient. A button 245 links the health care professional to another user interface 200 displaying information relating to the patient condition, as shown in FIG. 5f. One of the tabs is related to physician tools displays information relating one medicament for gastroesophogeal reflux disease, outlining dosing information, including efficacy charts, surveys related to the medicament.

The user interface 200 comprises advertisements corresponding to the patient condition. As the operator navigates through the numerous pages on the terminal 12, the operator can select any one of the pages presented on the user interface 200, such as treatment options and educational materials pertaining to the patient condition. In addition, the operator can capture any of the images of the human anatomy corresponding to the patient's condition, including any annotations and specials instructions entered by the health care professional. The selected pages and captured screenshots of the user interface 200 are associated with the patient information to generate a report corresponding to the medical consultation. The report may be comprehensive, and may further include date of consultation, attending physician, reason for consultation, history of present patient condition or illness, past medical history, past surgical history, medications on admission, allergies, social history such as tobacco, alcohol or illegal substance abuse, review of the systems, physical examination, laboratory data, recommendations, treatment options and plan, follow-up visit.

Typically, the report is added to the existing patient record on the user database 54, otherwise a new patient record is created. The report, or any portion thereof, may be printed and handed to the patient, or it can be forwarded directly to the patient or third party, such as a health insurer or caregiver, via email, snail mail or facsimile. For example, as shown in FIG. 5c, an email message may be sent to the patient directly from the terminal 12 via the messaging server 58 by actuating the email button 246 on the user interface 200. Alternatively, the patient report may be accessible via an FTP or HTTP web portal. Accordingly, the patient is provided a complete record of the medical consultation for future reference.

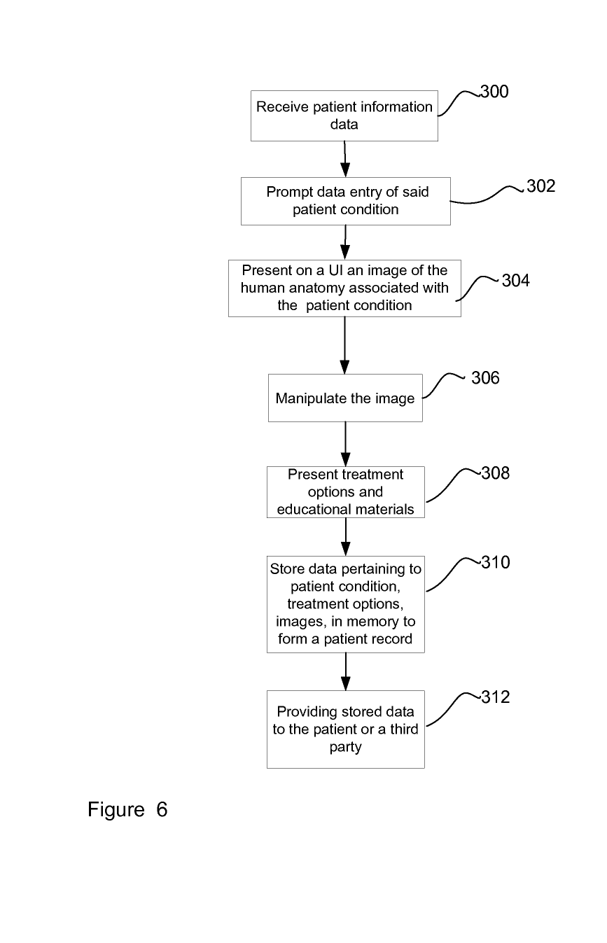

Looking at FIG. 6, a flow chart diagram illustrates an exemplary method for generating a patient report of a medical consultation by a health care professional using a medical terminal, the method comprising the steps of, via said terminal: receiving patient information data (step 300); prompting data entry of said patient condition via a graphical user interface (GUI) associated with said terminal to provide a query associated with said patient condition in real-time; (step 302); presenting on said GUI at least one image of the human anatomy associated with said entered patient condition in real-time (step 304); manipulating said at least one image (step 306); presenting on said GUI a recommended prescription for said patient condition including information related to said patient condition and said prescription (step 308); storing on a computer readable medium said patient information data, said at least one image, said prescription data in a database structure (step 310); and providing said patient information data, said at least one image, said prescription data (step 312) to said patient or a third party.

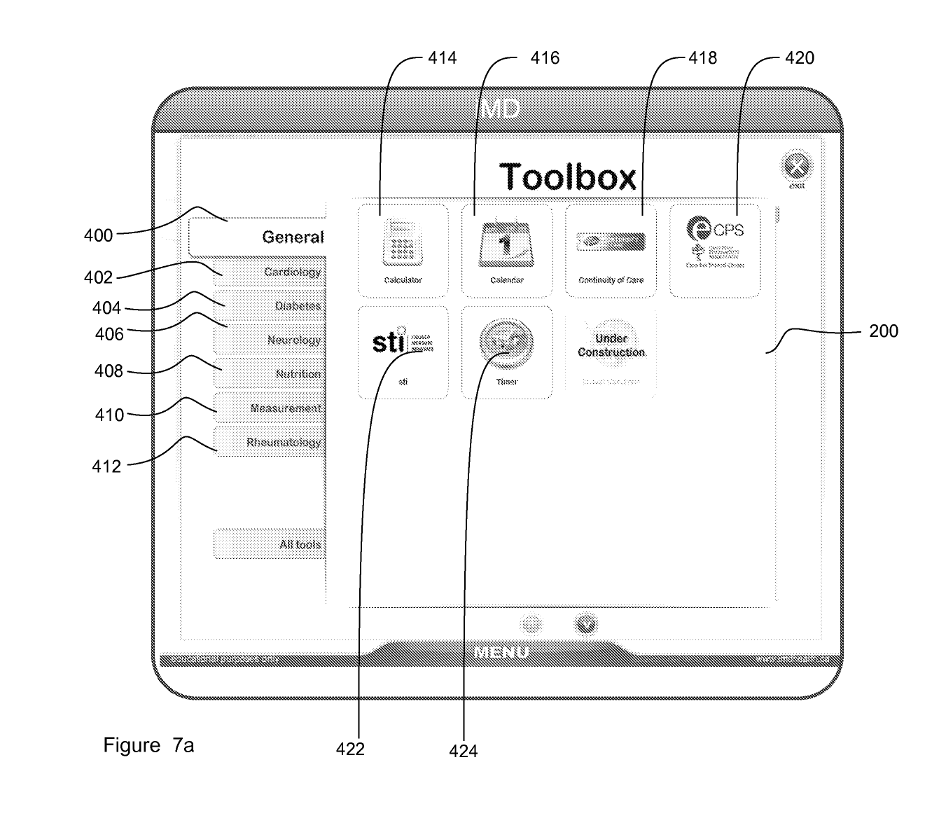

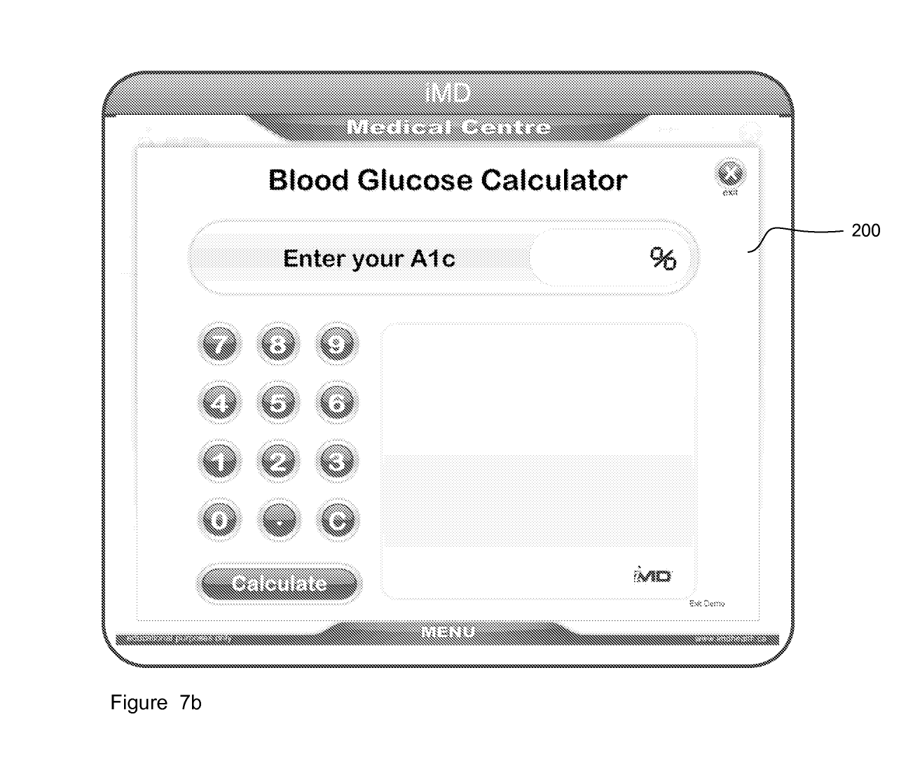

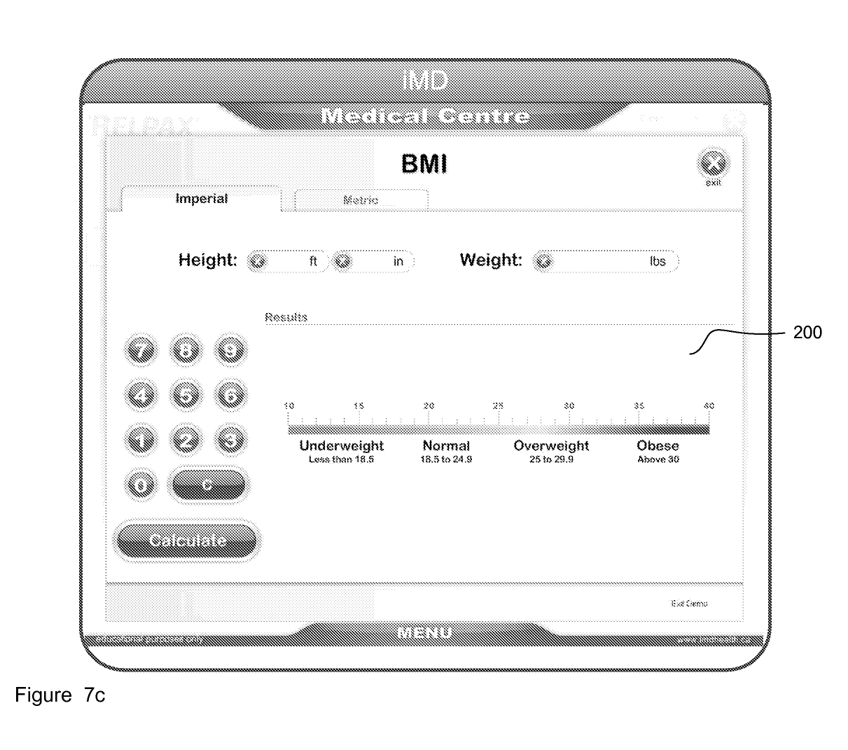

Now referring to FIG. 7a, there is shown an exemplary user interface 200 with a plurality of medical tools related to different patient conditions, measurements, nutrition, among others, with associated tabs 400, 402, 404, 406, 408, 410, 412. As an example, selecting tab 400 displays a plurality of GUI objects 414, 416, 418, 420, 422, 424 associated with a plurality of applications or uniform resource indicators (URIs). For example, selecting GUI object 414 launches a calculator application, while selecting GUI object 420 launches a page associated with a third party resource provider. Selecting tab 404 displays GUI objects associated with tools relating diabetes, such as a blood glucose calculator, as shown in FIG. 7b. Selecting tab 410 displays GUI objects associated with measurement tools such as a body mass index (BMI) as shown in FIG. 7c.

In another embodiment, the system 10 has the facility for pathological material to be added as an illustrative point when regional anatomy is being demonstrated.

In yet another embodiment, the user interface 200 comprises targeted advertisements corresponding to the patient condition.

In yet another embodiment, the system 10 has provides a searchable, customizable map of the human body.

In yet another embodiment, the system 10 has provides a method for soliciting feedback from patients and health care professionals through surveys.

In yet another embodiment, the system 10 provides a method for providing alerts to patients post-medical consultation. Alerts may also be provided to health care professionals and third parties, such as, insurance providers, pharmaceutical companies, and so forth.

The communication network 16 can include a series of network nodes (e.g., the clients and servers) that can be interconnected by network devices and wired and/or wireless communication lines (such as, public carrier lines, private lines, satellite lines, etc.) that enable the network nodes to communicate. The transfer of data between network nodes can be facilitated by network devices, such as routers, switches, multiplexers, bridges, gateways, etc., that can manipulate and/or route data from an originating node to a server node regardless of dissimilarities in the network topology (such as, bus, star, token ring, mesh, or hybrids thereof), spatial distance (such as, LAN, MAN, WAN, Internet), transmission technology (such as, TCP/IP, Systems Network Architecture), data type (such as, data, voice, video, multimedia), nature of connection (such as, switched, non-switched, dial-up, dedicated, or virtual), and/or physical link (such as, optical fiber, coaxial cable, twisted pair, wireless, etc.) between the correspondents within the network.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises,” “comprising,” or any other variations thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical.”

The preceding detailed description of exemplary embodiments of the invention makes reference to the accompanying drawings, which show the exemplary embodiment by way of illustration. While these exemplary embodiments are described in sufficient detail to enable those skilled in the art to practice the invention, it should be understood that other embodiments may be realized and that logical and mechanical changes may be made without departing from the spirit and scope of the invention. For example, the steps recited in any of the method or process claims may be executed in any order and are not limited to the order presented. Further, the present invention may be practiced using one or more servers, as necessary. Thus, the preceding detailed description is presented for purposes of illustration only and not of limitation, and the scope of the invention is defined by the preceding description, and with respect to the attached claims.

The embodiments of the invention in which an exclusive property or privilege is claimed are defined as follows:

1. An apparatus comprising a non-transitory computer readable medium with instructions stored thereon, said instructions executable by a processor to cause the processor to:
prompt a user to input a query pertaining to a patient condition via a graphical user interface (GUI) of said apparatus;
retrieve at least one anatomical representation of a human body in response to said query;
present said at least one anatomical representation associated with said patient condition on said GUI;
allow manipulation of said at least one anatomical representation through scaling, rotation, dragging and annotation;
recommend treatment options and medicaments for a prescription;
provide educational material pertaining to said patient condition;
compile a report pertaining to said patient condition, said report including said at least one anatomical representation, said treatment options, said medicaments with associated data; and
provide said report to said patient via electronic means.

2. The apparatus of claim 1 wherein said user interface comprises a plurality of GUI objects associated with said patient conditions.

3. The apparatus of claim 2 wherein said query is input by selecting one of said plurality of GUI objects.

4. The apparatus of claim 3 wherein said user interface comprises a complete anatomical representation of a human body, wherein said query is input by selecting one of said least one anatomical representation corresponding to said patient condition on said complete representation of said human body.

5. The apparatus of claim 4 wherein said GUI comprises a first partition for displaying said GUI objects and a second partition for displaying complete representation of said human body.

6. The apparatus of claim 4 wherein said least one anatomical representation comprises one of a 2-dimensional image, a 3-dimensional image and multimedia content, or a combination thereof.

7. The apparatus of claim 6 wherein said at least one anatomical representation is retrieved from a remote computing entity.

8. The apparatus of claim 6 wherein said at least one anatomical representation is cached on said computer readable medium.

9. The apparatus of claim 1 wherein said report is provide via at least one of email, SMS, voice mail, facsimile, web portal and ftp portal.

10. A method for generating a patient report of a medical consultation by a health care professional using a terminal, the method comprising the steps of, via said terminal:
receiving patient information data;
prompting data entry of said patient condition via a graphical user interface (GUI) associated with said terminal to provide a query associated with said patient condition;
presenting on said GUI at least one image of the human anatomy associated with said entered patient condition;
manipulating said at least one image;
presenting on said GUI a recommended prescription for said patient condition including information related to said patient condition and said prescription;
storing on a computer readable medium said patient information data, said at least one image, said prescription data in a database structure; and
providing said patient information data, said at least one image, said prescription data.

11. The method of claim 10 wherein said at least one image is one of a 2-dimensional image, a 3-dimensional image and multimedia content, or a combination thereof.

12. The method of claim 10 wherein said patient information data, said at least one image, said prescription data at least one image of the human anatomy is stored on a said terminal.

13. The method of claim 10 wherein said patient information data, said at least one image, said prescription data at least one image of the human anatomy is retrieved from a remote computing entity in real-time.

14. The method of claim 12 wherein the step of providing said patient information data, said at least one image and said prescription data, comprises a further step of transmitting said report via electronic means to said patient or an authorized third party.

15. A system for generating a patient report of a medical consultation by a health care professional, the system comprising:
a central server for processing requests from at least one client terminal associated with said health care professional;
a content server communicatively coupled to the central server, said content server comprising content associated with at least one patient condition;
a health care professional information database comprising user objects pertaining to a medical facility having said at least one client terminal;
a patient information database comprising user objects pertaining to said patient; and
a messaging server for sending said report from the medical consultation to said patient or an authorized third party.

16. The system of claim 15 wherein said central server comprises at least one server process that responds to requests from one or more client programs of said terminals.

17. The system of claim 16 wherein said health care professional information database comprises user objects relating to at least one of: identification data and geographical location, authorized health care professional details, terminal data, and said a patient information database comprises user objects relating to at least one of: name, gender, contact information details, such as email address or phone number, records of medical consultations, and a patient medical history.

18. The system of claim 16 wherein said terminal data comprises at least one of a software application version, hardware version, user information, and analytics data.

19. The system of claim 17 wherein said central server remotely provides periodic updates for software application based on said terminal data.

20. The system of claim 15 further comprising a third party database having information pertaining to a medicament associated with said patient condition.

21. The system of claim 16 wherein said content comprises medical illustrations, industry guidelines, videos, documents, multimedia, drug information, detailing aids, monographs, research documents, patient literature, and public health awareness information.

22. The system of claim 21 wherein said content is presented to said terminal in real-time from said content server in response to a query on said at least one terminal, and displayed on a user interface of said at least one terminal to aid in the education of said patient about said patient condition.

23. The system of claim 21 wherein said content is provided to said terminal for caching thereon, and displayed on a user interface of said at least one terminal in response to a query on said at least one terminal.

24. The system of claim 21 wherein said messaging server receives requests from said terminals via said central server to send selected medical content by said health care professional, including patient reports from the medical consultation.
